(19) United States
(12) Patent Application Publication
(10) Pub. No.: US 2026/0001112 A1
(43) Pub. Date: Jan. 1, 2026

(54) DEVICE AND METHOD FOR CONTINUOUS RECOVERY OF AMMONIANITROGEN FROM ALUMINUM ASH

(71) Applicants: TONGJI UNIVERSITY, SHANGHAI (CN); ONCE ENVIRONMENTAL PROTECTION SCIENCE & TECHNOLOGY (SHANGHAI) CO., LTD., SHANGHAI (CN)

(72) Inventors: FENGTING LI, SHANGHAI (CN); LU LI, SHANGHAI (CN); JIE LI, SHANGHAI (CN)

(73) Assignees: TONGJI UNIVERSITY, SHANGHAI (CN); ONCE ENVIRONMENTAL PROTECTION SCIENCE & TECHNOLOGY (SHANGHAI) CO., LTD., SHANGHAI (CN)

(21) Appl. No.: 19/250,110

(22) Filed: Jun. 26, 2025

(30) Foreign Application Priority Data
Jun. 26, 2024 (CN) 2024108308264

(51) Int. Cl. B09B 3/45; B01J 8/00; B01J 8/08; B09B 101/55; C01C 1/02

(52) U.S. Cl. CPC B09B 3/45; B01J 8/0045; B01J 8/085; B01J 8/087; C01C 1/026; B01J 2208/00371; B01J 2208/00752; B09B 2101/55

(57) ABSTRACT

The present invention relates to a device and method for continuous recovery of ammonia nitrogen from aluminum ash. The device comprises a reaction kettle, a steam generator, and a feeder. The steam generator and the feeder are both mounted on the reaction kettle. The steam generator delivers steam into the reaction kettle, and the feeder is used to deliver aluminum ash into the reaction kettle. The device further includes an intersection dispersion assembly and a cyclic motion assembly. The intersection dispersion assembly is installed inside the reaction kettle and is used for intersecting and dispersing the steam and aluminum ash. In the present invention, operations are performed in sequence on two dispersion surfaces. Both helical surfaces of the blade are used, which improves space utilization and increases the total dispersion area. Within one cycle, aluminum ash is spread and scraped completely, effectively improving processing efficiency.

### TECHNICAL FIELD

The present invention relates to the technical field of solid waste treatment equipment, and more specifically to a device and method for continuous recovery of ammonia nitrogen from aluminum ash.

### BACKGROUND

The generation of aluminum ash in the aluminum production industry is inevitable. Aluminum ash produced during the aluminum recovery process is classified as hazardous solid waste due to its reactivity and toxicity. Since aluminum ash contains a certain amount of nitrogen, irritating ammonia gas is generated during the deliquescence process. The release of ammonia gas under conventional environmental conditions results in environmental pollution.

To prevent ammonia gas from being released during the storage of aluminum ash and causing environmental pollution, ammonia nitrogen in aluminum ash is typically recovered. Conventional techniques for recovering ammonia nitrogen from aluminum ash generally adopt a water soaking method or a heated boiling water method. In practical applications, the water soaking method is less efficient and therefore the heated boiling water method is more commonly used. However, when using the heated boiling water method, on one hand, excessive water consumption results in a high moisture content in the aluminum ash after ammonia nitrogen removal. This not only leads to severe water resource waste but also hinders subsequent storage. On the other hand, during the boiling water process, the control over the reaction rate of aluminum ash is poor, making it difficult to regulate the ammonia generation rate. This, in turn, places considerable pressure on the subsequent procedures of ammonia purification and recovery.

To address the above issues, related technologies generally attempt to control the reaction rate by adjusting the feed rates of aluminum ash or water, and by reducing the amount of water used to enhance the implementation efficiency of the aluminum ash treatment process. For example, Chinese Patent Publication No. 2020113128704 discloses an aluminum ash deamination device and deamination process. In this solution, water vapor is used to heat the aluminum ash in a layered manner, combined with multiple water additions, thereby achieving reaction rate control and water saving. However, in practical application, it was found that on one hand, due to the certain viscosity of the mixture after aluminum ash is combined with water, the mixing effect is poor during water addition, resulting in difficulty in controlling the reaction rate. On the other hand, during the initial stage of the reaction, the water content in the aluminum ash is low, which makes it difficult for the heat in the steam to be transferred to the aluminum ash, thus leading to a poor heating effect and further reducing the reaction rate. This results in a slow aluminum ash treatment rate. In view of this, the present invention proposes a device and method for continuous recovery of ammonia nitrogen from aluminum ash to solve the above-mentioned technical problems.

### SUMMARY

To overcome the deficiencies of the prior art and address the above-mentioned technical problems, the present invention proposes a device and method for continuous recovery of ammonia nitrogen from aluminum ash.

The technical solution adopted by the present invention to solve the aforementioned problems is as follows: the device for continuous recovery of ammonia nitrogen from aluminum ash comprises a reaction kettle, a steam generator, and a feeder. The steam generator and the feeder are both mounted on the reaction kettle. The steam generator delivers steam into the reaction kettle, and the feeder conveys aluminum ash into the reaction kettle. The device further comprises an intersection dispersion assembly and a cyclic motion assembly. The intersection dispersion assembly is installed inside the reaction kettle and is configured to intersect and disperse steam and aluminum ash. The intersection dispersion assembly includes a dispersion surface. A dispersion surface for dispersing the mixture of steam and aluminum ash is provided inside the reaction kettle. A dispersion plate is provided in the reaction kettle, with a docking slot formed on the side of the dispersion plate facing the dispersion surface. The dispersion plate fits with the dispersion surface in a gap-fitting manner. The docking slot is in communication with the feeder via a pipeline. The feeder is a pneumatic conveyor. A guide tube is fixedly mounted on the side wall of the dispersion plate. The guide tube is in communication with the steam generator. The guide tube is uniformly perforated and located inside the reaction kettle. A heating chamber is arranged inside the reaction kettle and corresponds to the dispersion surface. Heat conduction occurs between the heating chamber and the dispersion surface. The heating chamber is in communication with the steam generator. The cyclic motion assembly is mounted inside the reaction kettle and is used to control the cyclic relative motion between the dispersion plate and the dispersion surface.

Preferably, two sets of guide tubes are connected to the same dispersion plate, and the dispersion plate is located between the two sets of guide tubes.

Preferably, the cyclic motion assembly comprises a helical blade. A helical blade is rotatably mounted inside the reaction kettle. The heating chamber is arranged inside the helical blade. The helical surface of the helical blade forms the dispersion surface. A rotating shaft is rotatably mounted inside the reaction kettle and is externally connected to a drive motor. A connecting sleeve is fixedly mounted at the middle portion of the helical blade. The rotating shaft extends into the connecting sleeve. The rotating shaft is axially slidable with the connecting sleeve and is circumferentially constrained. A guide rod is fixedly mounted inside the reaction kettle and extends into the inner cavity of the connecting sleeve. A spiral groove is formed on the guide rod. An engagement tooth is fixedly mounted on the inner wall of the connecting sleeve and extends into the spiral groove. The dispersion plate is mounted on the reaction kettle and extends into the gap between the helical blades. A scraper is fixedly mounted on the dispersion plate. The scraper contacts the dispersion surface in an inclined manner and is made of elastic metal sheet.

Preferably, a sliding groove is formed on the reaction kettle. An electric telescopic rod is fixedly mounted in the sliding groove. The dispersion plate extends into the sliding groove and is slidably connected to the reaction kettle via the sliding groove. The electric telescopic rod is fixedly connected to the dispersion plate. Docking slots are formed on both sides of the dispersion plate, and both are in communication with the feeder. Scrapers and guide tubes are mounted on both sides of the dispersion plate.

Preferably, a communication slot is formed on the reaction kettle. The communication slot is connected to the feeder via a pipeline. The communication slots correspond one-to-one with the docking slots. Each communication slot is in communication with the sliding groove. Two sets of docking slots and communication slots are arranged on the same sliding groove. One set of docking and communication slots is aligned at the same time, while the other set is arranged in a staggered manner.

Preferably, each scraper is provided with a baffle and a reinforcing plate. The reinforcing plate is fixedly mounted on the scraper. The baffle is fixedly mounted on the side of the scraper away from the dispersion surface.

Preferably, a collection box is fixedly mounted below the reaction kettle. A filter groove is formed at the bottom of the reaction kettle. A filter screen is fixedly mounted at the communication portion between the filter groove and the collection box. A scraper blade is slidably mounted in the filter groove. A connecting handle is rotatably mounted on the connecting sleeve and is fixedly connected to the scraper blade.

Preferably, a set of uniformly distributed comb teeth is fixedly mounted on the end of the scraper blade facing the filter screen. Misaligned teeth are fixedly mounted in the filter groove and are aligned with the comb teeth with a gap.

Preferably, partition plates are fixedly mounted in the collection box in a uniformly distributed manner, dividing the collection box into multiple chambers. The chambers of the collection box correspond one-to-one with the dispersion plate and feeder. A circulation pipe is fixedly mounted at the bottom of the collection box and is in communication with the feeder.

The method for continuous recovery of ammonia nitrogen from aluminum ash comprises the following steps:
S1: The aluminum ash particles ground by a ball mill are conveyed into the docking slot via the feeder, while saturated steam generated in the steam generator is conveyed into the guide tube;
S2: The drive motor is started to drive the helical blade to rotate and perform axial movement. In one complete cycle, the guide tube and the dispersion plate sequentially form a water vapor layer and an aluminum ash layer on the two dispersion surfaces, so that the aluminum ash comes into uniform contact with the water;
S3: Meanwhile, under the continuous heat exchange effect of the steam in the heating chamber, the water vapor and aluminum ash on the dispersion surface are heated. At this time, the aluminum ash reacts with the water, and after the reaction is completed, excess water vapor is evaporated;
S4: Starting from the second cycle, during the movement of the dispersion plate, the scraper mounted on its end face scrapes off the aluminum ash from the dispersion surface and reestablishes the water vapor layer and aluminum ash layer;
S5: The scraped aluminum ash falls into the collection box after being crushed and is conveyed to the next stage of the dispersion plate by the circulation pipe and feeder. The aluminum ash is thus repeatedly mixed and dispersed with water vapor until it fully reacts.

The beneficial effects of the present invention are as follows:
1. The device and method for continuous recovery of ammonia nitrogen from aluminum ash, as disclosed in the present invention, achieve uniform dispersion of water vapor and aluminum ash on the dispersion surface by forming a water vapor layer followed by an aluminum ash layer on the dispersion surface via the dispersion plate and guide tube. This ensures a relatively stable input ratio of aluminum ash and water vapor, allowing for high-precision control of the reaction degree. Moreover, since water vapor first adheres to the dispersion surface and heat is exchanged between the dispersion surface and the heating chamber, the heat first enters the water vapor and then transfers to the aluminum ash through the motion of water molecules. This utilizes the good thermal conductivity of water vapor to effectively transfer heat into the aluminum ash, enabling high controllability of the aluminum ash and water reaction in the reaction kettle and facilitating the deamination treatment of aluminum ash.
2. The device and method for continuous recovery of ammonia nitrogen from aluminum ash, as disclosed in the present invention, operate sequentially on two dispersion surfaces. On one hand, both helical surfaces of the helical blade serve as dispersion surfaces, further improving space utilization and significantly increasing the dispersion surface area. On the other hand, a complete cycle of aluminum ash laying and scraping is achieved within one cycle, effectively improving the treatment efficiency of aluminum ash.

### BRIEF DESCRIPTION OF THE DRAWINGS

The present invention is further described below with reference to the accompanying drawings.

FIG. 1 is a perspective view of the present invention;

FIG. 2 is a perspective view from another angle of the present invention;

FIG. 3 is an assembled perspective view of the helical blade, the rotating shaft, and the guide rod;

FIG. 4 is a sectional view of the connecting sleeve;

FIG. 5 is an enlarged partial view at A in FIG. 4;

FIG. 6 is a perspective view of the dispersion plate;

FIG. 7 is a partial sectional view of the present invention;

FIG. 8 is an assembled perspective view of the comb teeth, the misaligned teeth, and the scraper blade;

FIG. 9 is a perspective view of the guide tube;

FIG. 10 is a sectional view of the sliding groove;

FIG. 11 is an enlarged partial view at B in FIG. 10;

FIG. 12 is a flowchart of the method of the present invention.

In the drawings: 1, reaction kettle; 11, steam generator; 12, feeder 2, dispersion surface 21, dispersion plate; 22, guide tube; 23, docking slot; 24, heating chamber; 25, helical blade; 26, rotating shaft; 27, connecting sleeve; 3, drive motor; 31, guide rod; 32, spiral groove; 33, engagement tooth; 4, scraper; 41, baffle; 42, reinforcing plate; 5, sliding groove; 51, electric telescopic rod; 52, communication slot; 6, collection box; 61, filter groove; 62, filter screen; 63, scraper blade; 64, connecting handle; 65, comb teeth; 66, misaligned teeth; 7, partition plate; 71, circulation pipe.

### DETAILED DESCRIPTION

To facilitate understanding of the technical means, inventive features, objectives, and effects achieved by the present invention, the following provides a detailed description of the invention in conjunction with specific embodiments.

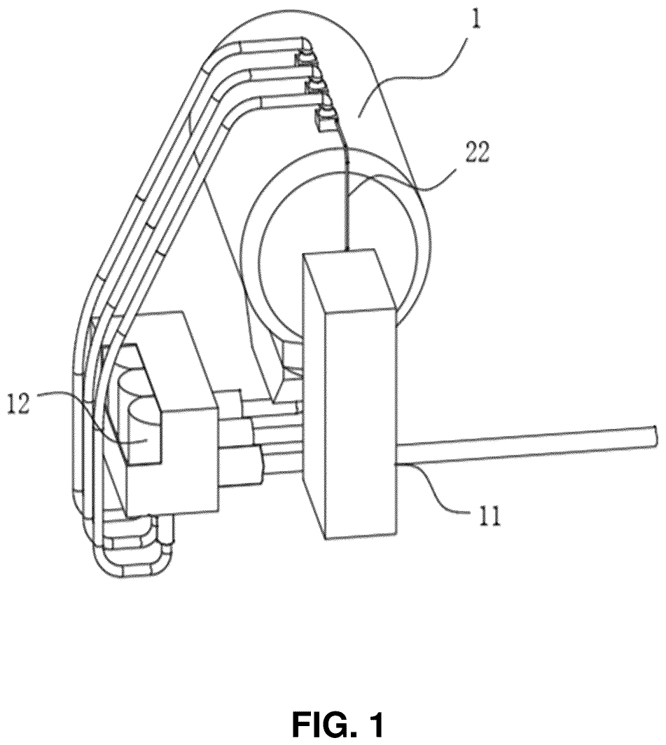

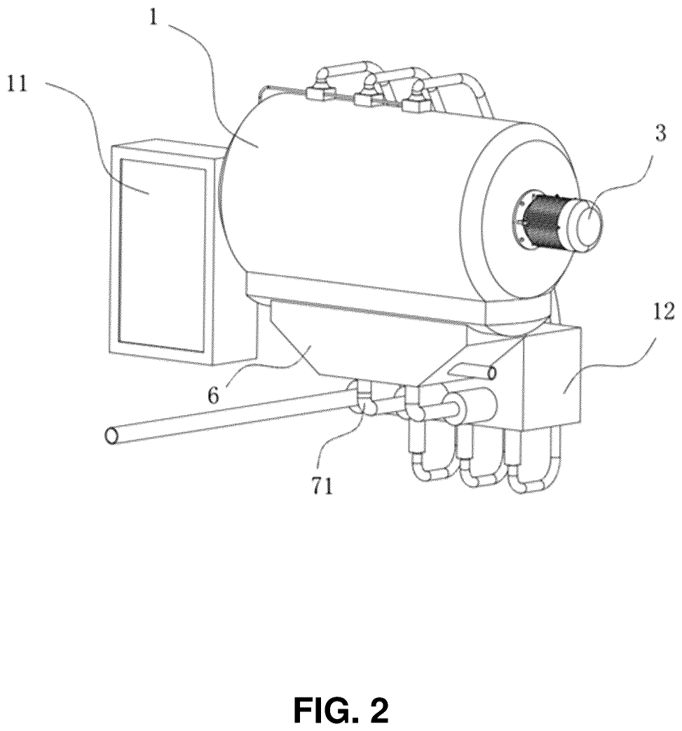

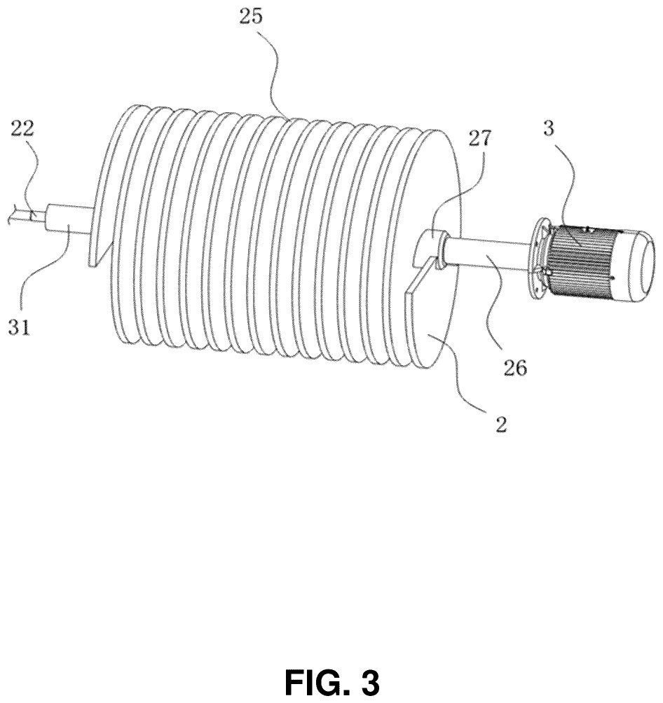

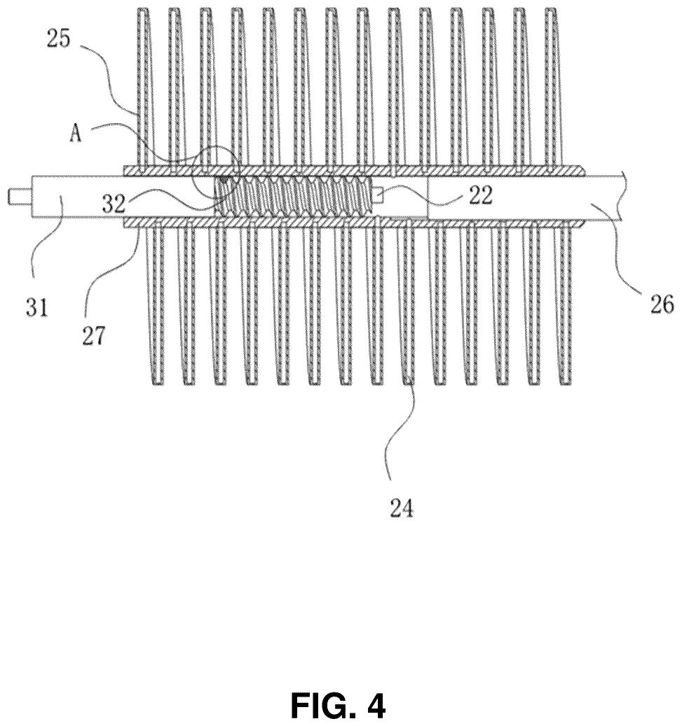

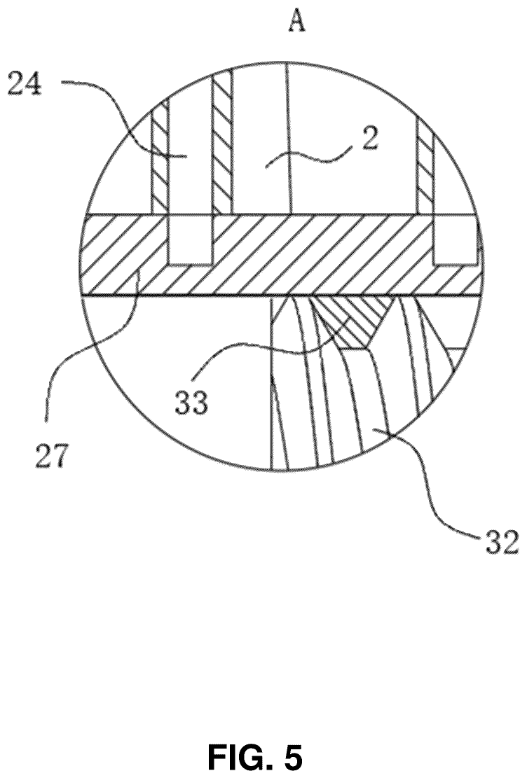

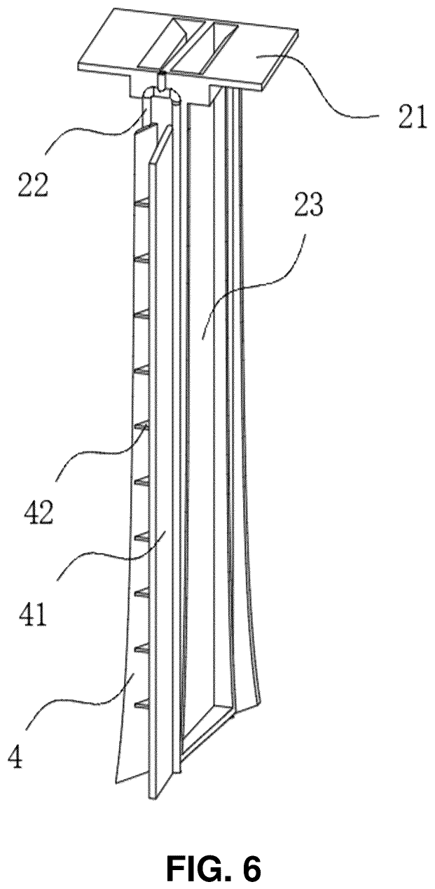

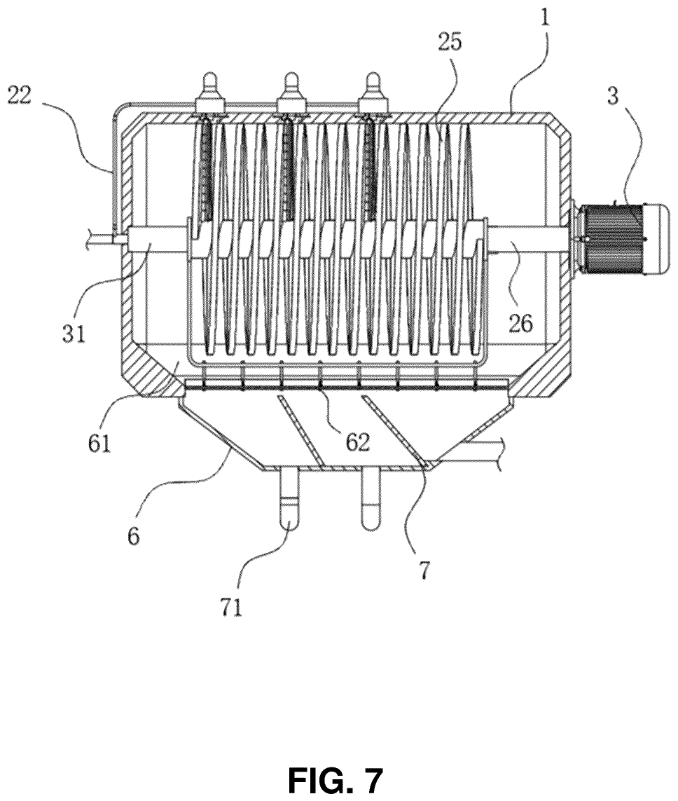

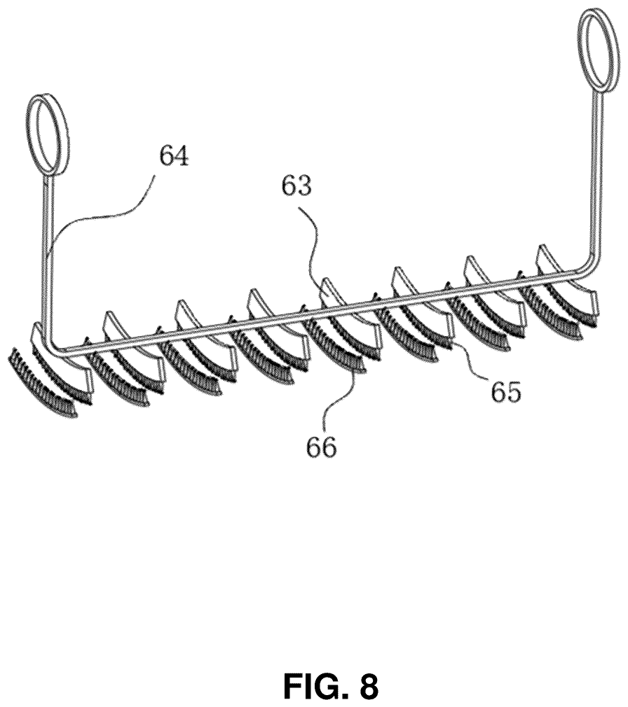

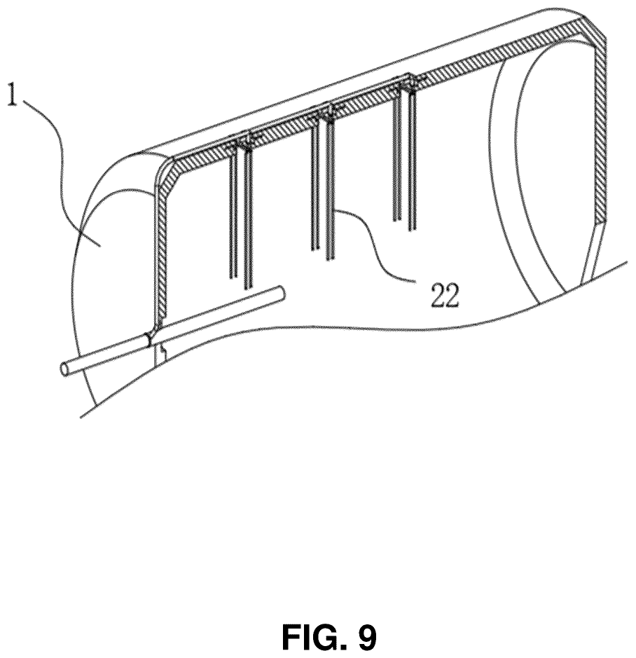

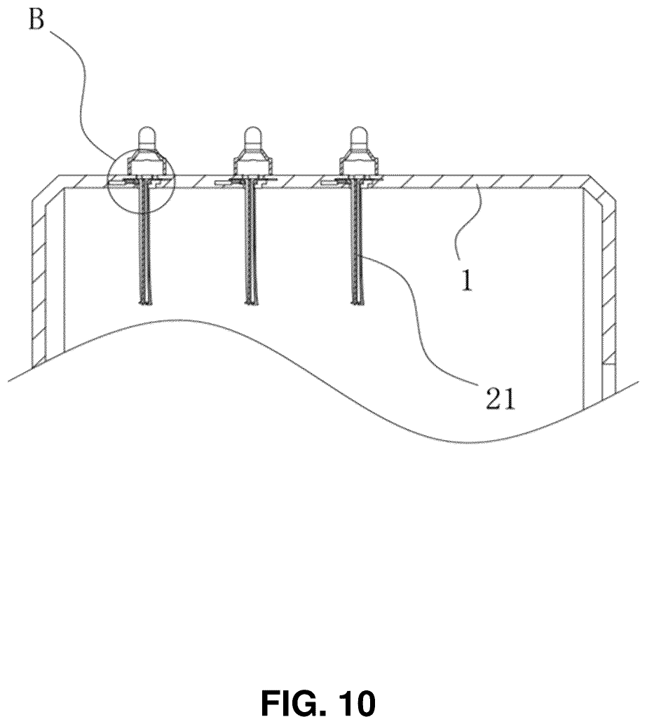

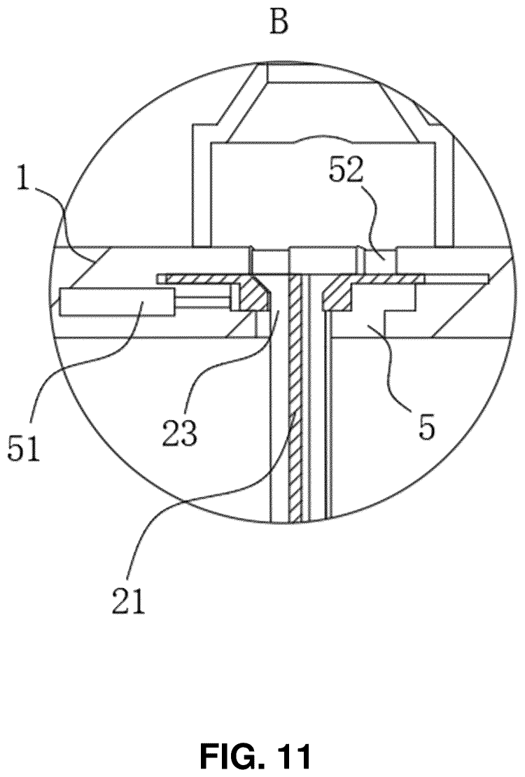

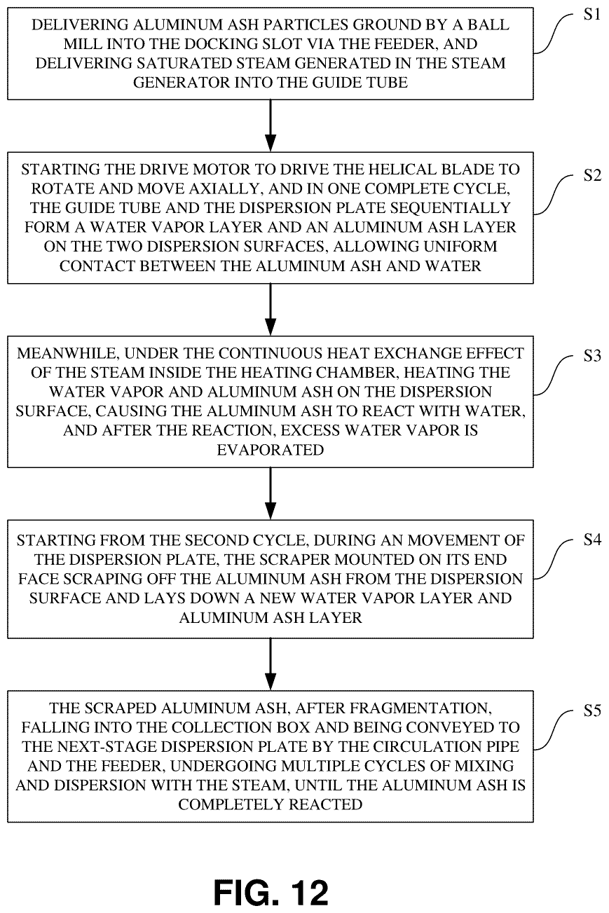

As shown in FIGS. 1 to 12, the device for continuous recovery of ammonia nitrogen from aluminum ash according to the present invention comprises a reaction kettle 1, a steam generator 11, and a feeder 12. The steam generator 11 and the feeder 12 are both mounted on the reaction kettle 1. The steam generator 11 delivers steam into the reaction kettle 1, and the feeder 12 is used to deliver aluminum ash into the reaction kettle 1. The device further includes an intersection dispersion assembly 20 and a cyclic motion assembly 25a. The intersection dispersion assembly 20 is installed inside the reaction kettle 1 and is used for intersecting and dispersing the steam and aluminum ash. The intersection dispersion assembly 20 includes a dispersion surface 2, which is provided inside the reaction kettle 1 for dispersing the steam and aluminum ash mixture. A dispersion plate 21 is arranged in the reaction kettle 1. A docking slot 23 is formed on the side of the dispersion plate 21 facing the dispersion surface 2. The dispersion plate 21 fits with the dispersion surface 2 in a gap-fitting manner. The docking slot 23 is connected to the feeder 12 via a pipeline 230. The feeder 12 is a pneumatic conveyor. A guide tube 22 is fixedly mounted on the side wall of the dispersion plate 21. The guide tube 22 is connected to the steam generator 11 and is uniformly perforated inside the reaction kettle 1. A heating chamber 24 is arranged within the reaction kettle 1 and corresponds to the dispersion surface 2. Heat is transferred between the heating chamber 24 and the dispersion surface 2. The heating chamber 24 is connected to the steam generator 11. The cyclic motion assembly 25a is mounted inside the reaction kettle 1 and is used to control the cyclic relative motion between the dispersion plate 21 and the dispersion surface 2.

During the recovery of ammonia nitrogen from aluminum ash, aluminum ash typically reacts with water to separate the ammonia nitrogen component in the form of ammonia gas. Combined with continuous recovery of ammonia gas, this process reduces environmental pollution caused by long-term storage of aluminum ash and enables the rational use of resources. During the deamination process of aluminum ash, the uniform mixing of aluminum ash and water ensures the normal progress of the reaction while reducing water usage. Moreover, the even dispersion and controlled thickness of the aluminum ash and water mixture facilitate both the rapid release of ammonia gas and the stable transfer of heat.

Specifically, during aluminum ash treatment, the steam generator 11 and the feeder 12 are first activated. The steam generator 11 heats water to produce saturated steam, while the feeder 12, being a pneumatic conveyor, uses compressed air to deliver the ground aluminum ash through a pipeline. The steam generated by the steam generator 11 is delivered to the heating chamber 24 and the guide tube 22. Driven by the cyclic motion assembly, the dispersion plate 21 and the guide tube 22 mounted thereon perform relative movement with respect to the dispersion surface 2. During this process, steam inside the guide tube 22 is sprayed onto the dispersion surface 2, moistening its surface. Subsequently, the aluminum ash transported by the feeder 12 using compressed airflow is delivered into the docking slot 23 on the dispersion plate 21 and, due to the impact of the airflow, is sprayed onto the dispersion surface 2. As the surface is already moistened, the aluminum ash adheres to the dispersion surface 2, while the airflow escapes through the gap between the dispersion plate 21 and the dispersion surface 2. As the dispersion plate 21 moves relative to the dispersion surface 2, it controls the thickness of the aluminum ash layer formed on the dispersion surface 2, resulting in a uniform layer. At this time, heat exchange continuously occurs between the heating chamber 24 and the dispersion surface 2, transferring the heat contained in the steam within the heating chamber 24 to the water droplets and aluminum ash layer on the dispersion surface 2. This causes the aluminum ash to react with water, and the ammonia nitrogen component in the aluminum ash is released as ammonia gas, which is then recovered via gas recovery equipment installed on the reaction kettle 1.

In the present invention, through the arrangement of the dispersion surface 2, the dispersion plate 21, and the guide tube 22, a layer of water vapor followed by a layer of aluminum ash is sequentially formed on the dispersion surface 2 during practical use. This enables uniform dispersion of water vapor and aluminum ash on the dispersion surface 2. On one hand, the input ratio of aluminum ash to water vapor remains relatively stable, ensuring high precision in controlling the reaction progress. On the other hand, since the water vapor first adheres to the dispersion surface 2, heat exchange between the dispersion surface 2 and the heating chamber 24 allows heat to first enter the water vapor, and then be transferred to the aluminum ash via the motion of water molecules. This facilitates the reaction between the water vapor and aluminum ash, leveraging the excellent thermal conductivity of water vapor to efficiently transfer heat to the aluminum ash. Consequently, the reaction between aluminum ash and water in the reaction kettle 1 is highly controllable, making the deamination treatment of aluminum ash more effective.

As a preferred embodiment of the present invention, two sets of guide tubes 22 are connected to the same dispersion plate 21, and the dispersion plate 21 is located centrally between the two sets of guide tubes 22, which are arranged on both sides of the dispersion plate 21. Under the action of the cyclic motion assembly 25a, relative motion occurs between the dispersion surface 2 and the dispersion plate 21. During this relative movement, steam is first sprayed onto the dispersion surface 2 to form a water vapor layer. Then, the docking slot 23 on the dispersion plate 21 guides the aluminum ash carried by airflow, causing it to be sprayed onto the dispersion surface 2 and combine with the water vapor layer to form an aluminum ash layer of uniform thickness. Subsequently, the second set of guide tubes 22 sprays steam again onto the surface of the aluminum ash layer. On one hand, steam is sprayed in two stages, allowing the water vapor to contact both sides of the aluminum ash layer, thereby enhancing the uniformity of mixing between steam and aluminum ash. On the other hand, spraying steam in two stages allows the first steam quantity to be reduced while maintaining a relatively stable steam-to-ash ratio. This reduces the moisture content of the initial water vapor layer on the dispersion surface 2, avoiding excessive accumulation of steam that might aggregate into large droplets and detach from the dispersion surface 2. Such detachment would not only hinder the uniform mixing of aluminum ash and water but also disrupt the desired ratio between them.

As another preferred embodiment of the present invention, the cyclic motion assembly 25a includes a helical blade 25. The helical blade 25 is rotatably mounted within the reaction kettle 1 and is made of a metallic material with high thermal conductivity. The heating chamber 24 is formed within the helical blade 25, and the helical surface of the helical blade 25 forms the dispersion surface 2. A rotating shaft 26 is rotatably mounted within the reaction kettle 1 and is externally connected to a drive motor 3. A connecting sleeve 27 is fixedly mounted at the middle section of the helical blade 25. The rotating shaft 26 extends into the connecting sleeve 27 and is axially slidable with respect to the connecting sleeve 27, while being circumferentially constrained. A guide rod 31 is fixedly mounted inside the reaction kettle 1 and extends into the inner cavity of the connecting sleeve 27. A spiral groove 32 is formed on the guide rod 31. Engagement teeth 33 are fixedly mounted on the inner wall of the connecting sleeve 27 and extend into the spiral groove 32. The dispersion plate 21 extends into the gap of the helical blade 25, and a scraper 4 is fixedly mounted on the dispersion plate 21. The scraper 4 contacts the dispersion surface 2 in an inclined manner and is made of an elastic metal sheet.

To enhance heat transfer efficiency between the dispersion surface 2 and the aluminum ash, while maintaining a suitable adhesion of the aluminum ash layer on the dispersion surface 2, the layer thickness must remain relatively small. Therefore, to maintain the treatment performance of the aluminum ash, the effective dispersion area within the reaction kettle 1 needs to be increased. This is achieved by rotatably installing the helical blade 25 within the reaction kettle 1 and using its helical surface as the dispersion surface 2, thereby increasing the dispersion area through optimal spatial utilization. The dispersion surface 2 also communicates well with the inner chamber of the reaction kettle 1, facilitating the release of generated ammonia gas. In the present invention, the helical blade 25 and the connecting sleeve 27 are integrally cast. The heating chamber 24 extends into the connecting sleeve 27 and communicates with its inner cavity. The guide tube 22 penetrates through the guide rod 31 and communicates with the inner cavity of the connecting sleeve 27, allowing steam to enter both the connecting sleeve 27 and the heating chamber 24. As the water vapor layer and aluminum ash layer are successively formed on the dispersion surface 2, the operator activates the drive motor 3, which is fixedly installed on the exterior of the reaction kettle 1. Its output shaft extends into the reaction kettle 1 and is fixedly connected to the rotating shaft 26. Under the action of the drive motor 3, the rotating shaft 26 rotates at a constant speed. Since the rotating shaft 26 is axially slidable and circumferentially constrained with respect to the connecting sleeve 27 (in this embodiment, the design of the shapes of the rotating shaft 26 and connecting sleeve 27 ensures they cannot rotate relative to each other; in other embodiments, other mechanisms may be used to allow axial sliding but prevent circumferential rotation), when the rotating shaft 26 rotates, it drives the connecting sleeve 27 and the helical blade 25 to rotate at a constant speed. Furthermore, the other end of the inner cavity of the connecting sleeve 27 is engaged with the spiral groove 32 of the guide rod 31 via the engagement teeth 33. Therefore, as the connecting sleeve 27 rotates, the engagement teeth 33 move along the spiral groove 32, causing the connecting sleeve 27 and the helical blade 25 to perform simultaneous rotational and axial movement. Since the dispersion plate 21 extends into the gap of the helical blade 25 and fits with the dispersion surface 2 in a gap-fitting manner, relative motion is generated between the dispersion plate 21 and the helical dispersion surface 2 as the helical blade 25 rotates and moves. Consequently, a water vapor layer followed by an aluminum ash layer is successively formed on the dispersion surface 2 of the helical blade 25. When the drive motor 3 has been running for a preset period, it reverses direction, causing the helical blade 25 to move in the opposite direction. When the helical blade 25 returns to its initial position relative to the dispersion plate 21, the system automatically switches the rotation direction of the drive motor 3 under program control. At this time, under the action of the scraper 4, the reacted mixture of aluminum ash and water on the dispersion surface 2 is scraped off. Then, steam and aluminum ash are again sprayed sequentially onto the dispersion surface 2, thereby achieving continuous treatment of the aluminum ash and ensuring the stable generation of ammonia gas.

As a preferred embodiment of the present invention, a sliding groove 5 is formed on the reaction kettle 1. An electric telescopic rod 51 is fixedly installed inside the sliding groove 5. The dispersion plate 21 extends into the sliding groove 5 and is slidably connected to the reaction kettle 1 via the sliding groove 5. The electric telescopic rod 51 is fixedly connected to the dispersion plate 21. Docking slots 23 are formed on both sides of the dispersion plate 21, and both docking slots 23 are in communication with the feeder 12. Scrapers 4 and guide tubes 22 are also installed on both sides of the dispersion plate 21.

During the dispersion and mixing process of aluminum ash and steam, one forward and one reverse rotation of the drive motor 3 constitute a complete cycle. Within one cycle, the helical blade 25 completes one reciprocating motion. When the drive motor 3 rotates through half a cycle, the electric telescopic rod 51 is activated under program control to push the dispersion plate 21, thereby generating a linear relative movement between the dispersion plate 21 and the helical blade 25. Since the helical blade 25 features two continuous helical surfaces, each located on either side of the dispersion plate 21 and both serving as dispersion surfaces 2, the movement of the dispersion plate 21 increases its distance from one helical surface while reducing its distance from the other. Given that docking slots 23, scrapers 4, and guide tubes 22 are installed symmetrically on both sides of the dispersion plate 21, after the drive motor 3 rotates for half a cycle, the dispersion plate 21 switches its engagement from one dispersion surface 2 to the other. As a result, within a single cycle, operations are carried out successively on both dispersion surfaces 2. On one hand, this configuration enables both helical surfaces of the helical blade 25 to serve as dispersion surfaces 2, improving spatial utilization and significantly increasing the overall dispersion area. On the other hand, it allows for a complete cycle of aluminum ash spreading and scraping, thereby improving the efficiency of aluminum ash treatment.

As another preferred embodiment of the present invention, a communication slot 52 is formed on the reaction kettle 1. The communication slot 52 is connected to the feeder 12 via a pipeline and corresponds one-to-one with the docking slot 23. Each communication slot 52 is connected to the sliding groove 5. Two sets of docking slots 23 and communication slots 52 are provided on the same sliding groove 5. At any given time, one set of docking and communication slots is aligned while the other set is misaligned. Since the communication slots 52 are connected to the feeder 12 via pipelines, aluminum ash carried by airflow can enter the communication slots 52. However, due to the distribution of the communication slots 52 on both sides of the sliding groove 5 with spacing greater than that of the docking slots 23, only one set is aligned in the initial state, while the other set remains misaligned. Thus, aluminum ash is directed into the docking slot 23 on the side of the dispersion plate 21 currently engaging with the dispersion surface 2. When the dispersion plate 21 moves within the sliding groove 5, the opposite set of docking and communication slots becomes aligned and operational, while the initially aligned set becomes misaligned. This arrangement ensures that aluminum ash is consistently blown onto the active dispersion surface 2 and reduces the likelihood of aluminum ash leaking in large quantities inside the reaction kettle 1. It is noted that the guide tubes 22, which serve as steam delivery passages, remain in continuous operation to provide stable steam input into the reaction kettle 1.

As another preferred embodiment of the present invention, each scraper 4 is provided with a baffle 41 and a reinforcing plate 42. The reinforcing plate 42 is fixedly mounted on the scraper 4, and the baffle 41 is fixedly mounted on the side of the scraper 4 away from the dispersion surface 2. The reinforcing plate 42 increases the resistance to deformation of the scraper 4. After the aluminum ash has reacted with water and lost moisture through sustained heat transfer, the scraped aluminum ash tends to form flakes. As these flakes move along the surface of the scraper 4, they are obstructed by the reinforcing plate 42, which induces uneven stress and increases their degree of fragmentation, making it easier for the ash to fall downward. The baffle 41 serves to block and guide the movement of aluminum ash, thereby reducing the chance of falling aluminum ash interfering with the opposite dispersion surface 2.

As a preferred embodiment of the present invention, a collection box 6 is fixedly installed below the reaction kettle 1. A filter groove 61 is formed at the bottom of the reaction kettle 1. A filter screen 62 is fixedly installed at the communication section between the filter groove 61 and the collection box 6. A scraper blade 63 is slidably installed inside the filter groove 61. A connecting handle 64 is rotatably mounted on the connecting sleeve 27 and is fixedly connected to the scraper blade 63. The collection box 6, located below the reaction kettle 1, serves to collect the falling aluminum ash. The filter screen 62 filters the aluminum ash, and during the axial movement of the connecting sleeve 27, it drives the connecting handle 64 and the scraper blade 63 to move. The scraper blade 63 pushes the aluminum ash across the filter screen 62, thereby achieving dynamic filtration of the aluminum ash.

As a preferred embodiment of the present invention, a set of uniformly distributed comb teeth 65 is fixedly installed on the end of the scraper blade 63 facing the filter screen 62. Misaligned teeth 66 are fixedly installed inside the filter groove 61 and aligned with the comb teeth 65 with a gap. As the scraper blade 63 moves, the comb teeth 65 are also moved. The flake-shaped aluminum ash located between the comb teeth 65 and the misaligned teeth 66 is broken under the action of shearing force, thus achieving fragmentation of the aluminum ash. With the cooperation of the filter screen 62, the final output aluminum ash particles exhibit a higher degree of uniformity.

As a preferred embodiment of the present invention, partition plates 7 are fixedly installed in the collection box 6 in a uniformly distributed manner, dividing the collection box 6 into multiple chambers. Each chamber corresponds to a dispersion plate 21 and a feeder 12. In this embodiment, multiple feeders 12 are arranged in parallel as a group. The number of feeders 12, the number of chambers partitioned within the collection box 6, and the number of dispersion plates 21 are all equal. A circulation pipe 71 is fixedly installed at the bottom of the collection box 6 and is in communication with the feeder 12. Under the guidance of the partition plates 7, the collection box 6 is divided into multiple chambers. During actual operation, each chamber of the collection box 6 corresponds to a dispersion plate 21. The aluminum ash scraped off the current dispersion plate 21 by the scraper 4 falls into the corresponding chamber of the collection box 6 and is conveyed to the next-stage dispersion plate 21 by means of the circulation pipe 71 and the feeder 12, after which it falls into the next chamber of the collection box 6. This enables the aluminum ash to undergo repeated steam-assisted reactions. On one hand, the multiple cycles of dispersion and mixing ensure a higher separation degree of ammonia nitrogen elements in the aluminum ash. On the other hand, the reaction time is extended, reducing the intensity of the reaction and thereby improving control over the degree of reaction of the aluminum ash.

A method for continuous recovery of ammonia nitrogen from aluminum ash comprises the following steps:
S1: The aluminum ash particles, ground by a ball mill, are delivered to the docking slot 23 via the feeder 12, while the saturated steam generated in the steam generator 11 is delivered into the guide tube 22.
S2: The drive motor 3 is started to drive the helical blade 25 to rotate and move axially. In one complete cycle, the guide tube 22 and the dispersion plate 21 sequentially form a water vapor layer and an aluminum ash layer on the two dispersion surfaces 2, ensuring uniform contact between aluminum ash and water.
S3: Meanwhile, under the continuous heat exchange effect of the steam inside the heating chamber 24, the water vapor and aluminum ash on the dispersion surface 2 are heated. At this time, the aluminum ash reacts with water, and after the reaction is complete, excess water vapor is evaporated.
S4: Beginning from the second cycle, during the movement of the dispersion plate 21, the scraper 4 mounted on its end face scrapes off the aluminum ash from the dispersion surface 2 and reestablishes a new water vapor layer and aluminum ash layer.
S5: The scraped aluminum ash falls into the collection box 6 after fragmentation and is transported to the next-stage dispersion plate 21 through the circulation pipe 71 and the feeder 12. The aluminum ash is repeatedly mixed and dispersed with water vapor until it fully reacts.

The above description and drawings illustrate the fundamental principles, main features, and advantages of the present invention. It should be understood by those skilled in the art that the present invention is not limited to the above-described embodiments. The embodiments and the descriptions provided herein are intended to explain the principles of the invention. Various modifications and improvements may be made without departing from the spirit and scope of the invention, and such modifications and improvements shall fall within the scope of protection defined by the appended claims and their equivalents.

1. A device for continuous recovery of ammonia nitrogen from aluminum ash, comprising a reaction kettle, a steam generator, and a feeder, wherein the steam generator and the feeder are both mounted on the reaction kettle, the steam generator is configured to deliver steam into the reaction kettle, and the feeder is configured to deliver aluminum ash into the reaction kettle;
wherein the device is characterized in that the device further comprises an intersection dispersion assembly, the intersection dispersion assembly is installed inside the reaction kettle and is configured to intersect and disperse the steam and aluminum ash;
the intersection dispersion assembly comprises a dispersion surface, the dispersion surface is provided inside the reaction kettle for dispersing the mixture of steam and aluminum ash;
a dispersion plate and a guide tube, wherein the dispersion plate is provided inside the reaction kettle, a docking slot is formed on a side of the dispersion plate facing the dispersion surface, the dispersion plate is fitted with the dispersion surface with a gap, the docking slot is in communication with the feeder via a pipeline, the feeder is a pneumatic conveyor, the guide tube is fixedly mounted on the side wall of the dispersion plate, the guide tube is in communication with the steam generator, and the guide tube is perforated evenly inside the reaction kettle;
a heating chamber, wherein the heating chamber is provided inside the reaction kettle and corresponds to the dispersion surface, heat conduction is performed between the heating chamber and the dispersion surface, and the heating chamber is in communication with the steam generator;
a cyclic motion assembly, wherein the cyclic motion assembly is installed inside the reaction kettle and is configured to control the cyclic relative movement between the dispersion plate and the dispersion surface.

2. The device for continuous recovery of ammonia nitrogen from aluminum ash according to claim 1, characterized in that two sets of guide tubes are connected to the same dispersion plate, and the dispersion plate is positioned between the two sets of guide tubes.

3. The device for continuous recovery of ammonia nitrogen from aluminum ash according to claim 1, characterized in that the cyclic motion assembly comprises:
a helical blade, the helical blade is rotatably mounted inside the reaction kettle, the heating chamber is provided inside the helical blade, and the helical surface of the helical blade constitutes the dispersion surface;
a rotating shaft and a connecting sleeve, wherein the rotating shaft is rotatably mounted inside the reaction kettle, the rotating shaft is externally connected to a drive motor, the connecting sleeve is fixedly mounted at a middle portion of the helical blade, the rotating shaft extends into the connecting sleeve, the rotating shaft is axially slidable with respect to the connecting sleeve, and the rotating shaft is circumferentially constrained relative to the connecting sleeve;
a guide rod, wherein the guide rod is fixedly mounted inside the reaction kettle and extends into an inner cavity of the connecting sleeve, a spiral groove is formed on the guide rod, an engagement tooth is fixedly mounted on an inner wall of the connecting sleeve, and the engagement tooth extends into the spiral groove;
a scraper, wherein the dispersion plate extends into a gap of the helical blade, the scraper is fixedly mounted on the dispersion plate, the scraper contacts the dispersion surface in an inclined manner, and the scraper is made of an elastic metal sheet.

4. The device for continuous recovery of ammonia nitrogen from aluminum ash according to claim 3, characterized in that a sliding groove is formed on the reaction kettle, an electric telescopic rod is fixedly mounted inside the sliding groove, the dispersion plate extends into the sliding groove and is slidably connected to the reaction kettle via the sliding groove, the electric telescopic rod is fixedly connected to the dispersion plate, docking slots are formed on both sides of the dispersion plate, both docking slots are in communication with the feeder, and scrapers and guide tubes are mounted on both sides of the dispersion plate.

5. The device for continuous recovery of ammonia nitrogen from aluminum ash according to claim 4, characterized in that a communication slot is formed on the reaction kettle, the communication slot is in communication with the feeder via a pipeline, the communication slot corresponds one-to-one with the docking slot, each communication slot is in communication with the sliding groove, two sets of docking slots and communication slots are arranged on the same sliding groove, one set of docking slots and communication slots is aligned at the same time, and the other set is staggered.

6. The device for continuous recovery of ammonia nitrogen from aluminum ash according to claim 4, characterized in that the scraper is provided with a baffle and a reinforcing plate, the reinforcing plate is fixedly mounted on the scraper, and the baffle is fixedly mounted on a side of the scraper away from the dispersion surface.

7. The device for continuous recovery of ammonia nitrogen from aluminum ash according to claim 4, characterized in that a collection box is fixedly mounted below the reaction kettle, a filter groove is formed at a bottom of the reaction kettle, a filter screen is fixedly mounted at a communication portion between the filter groove and the collection box, a scraper blade is slidably mounted inside the filter groove, a connecting handle is rotatably mounted on the connecting sleeve, and the connecting handle is fixedly connected to the scraper blade.

8. The device for continuous recovery of ammonia nitrogen from aluminum ash according to claim 7, characterized in that a set of uniformly distributed comb teeth is fixedly mounted on an end of the scraper blade facing the filter screen, misaligned teeth are fixedly mounted inside the filter groove, and the misaligned teeth are aligned with the comb teeth with a gap.

9. The device for continuous recovery of ammonia nitrogen from aluminum ash according to claim 8, characterized in that partition plates are fixedly mounted inside the collection box in a uniformly distributed manner, the partition plates divide the collection box into multiple chambers, and the chambers of the collection box correspond one-to-one with the dispersion plate and the feeder, a circulation pipe is fixedly mounted at the bottom of the collection box, and the circulation pipe is in communication with the feeder.

10. A method for continuous recovery of ammonia nitrogen from aluminum ash, characterized in that the method is applicable to a device for continuous recovery of ammonia nitrogen from aluminum ash,
wherein the device comprises a reaction kettle, a steam generator, and a feeder, wherein the steam generator and the feeder are both mounted on the reaction kettle, the steam generator is configured to deliver steam into the reaction kettle, and the feeder is configured to deliver aluminum ash into the reaction kettle;
wherein the device further comprises an intersection dispersion assembly, the intersection dispersion assembly is installed inside the reaction kettle and is configured to intersect and disperse the steam and aluminum ash;
the intersection dispersion assembly comprises a dispersion surface, the dispersion surface is provided inside the reaction kettle for dispersing the mixture of steam and aluminum ash;
a dispersion plate and a guide tube, wherein the dispersion plate is provided inside the reaction kettle, a docking slot is formed on a side of the dispersion plate facing the dispersion surface, the dispersion plate is fitted with the dispersion surface with a gap, the docking slot is in communication with the feeder via a pipeline, the feeder is a pneumatic conveyor, the guide tube is fixedly mounted on the side wall of the dispersion plate, the guide tube is in communication with the steam generator, and the guide tube is perforated evenly inside the reaction kettle;
a heating chamber, wherein the heating chamber is provided inside the reaction kettle and corresponds to the dispersion surface, heat conduction is performed between the heating chamber and the dispersion surface, and the heating chamber is in communication with the steam generator;
a cyclic motion assembly, wherein the cyclic motion assembly is installed inside the reaction kettle and is configured to control the cyclic relative movement between the dispersion plate and the dispersion surface, wherein the method comprises the following steps:
S1: delivering aluminum ash particles ground by a ball mill into the docking slot via the feeder, and delivering saturated steam generated in the steam generator into the guide tube;
S2: starting the drive motor to drive the helical blade to rotate and move axially, and in one complete cycle, the guide tube and the dispersion plate sequentially form a water vapor layer and an aluminum ash layer on the two dispersion surfaces, allowing uniform contact between the aluminum ash and water;
S3: meanwhile, under the continuous heat exchange effect of the steam inside the heating chamber, heating the water vapor and aluminum ash on the dispersion surface, causing the aluminum ash to react with water, and after the reaction, excess water vapor is evaporated;
S4: starting from the second cycle, during an movement of the dispersion plate, the scraper mounted on its end face scraping off the aluminum ash from the dispersion surface and lays down a new water vapor layer and aluminum ash layer;
S5: the scraped aluminum ash, after fragmentation, falling into the collection box and being conveyed to the next-stage dispersion plate by the circulation pipe and the feeder, undergoing multiple cycles of mixing and dispersion with the steam, until the aluminum ash is completely reacted.
